(19) United States
(12) Patent Application Publication
(10) Pub. No.: US 2004/0060635 A1
(43) Pub. Date: Apr. 1, 2004

(54) Method of producing an adhesive bond

(76) Inventors: Heinrich Diepers, Hoechstadt (DE); Recai Sezi, Roettenbach (DE)

Correspondence Address: LERNER AND GREENBERG, P.A., POST OFFICE BOX 2480, HOLLYWOOD, FL, 33022-2480, US

(21) Appl. No.: 10/670,663

(22) Filed: Sep. 25, 2003

(30) Foreign Application Priority Data
Sep. 25, 2002 (DE) 102 44 649.0

(51) Int. Cl. B32B 31/00

(52) U.S. Cl. 156/60

(57) ABSTRACT

In a method of bonding components, a poly-o-hydroxyamide is applied to each of the bond areas of the components to be bonded. After the bond areas have been bonded to one another the adhesively bonded assembly is heated in order to convert the poly-o-hydroxyamide to the corresponding polybenzoxazole. The adhesive bonding technology is able to replace conventional joining techniques, such as welding, brazing or shrink fitting. The method is especially suitable for producing X-ray image intensifiers.

### BACKGROUND OF THE INVENTION

### FIELD OF THE INVENTION

The invention relates to a method of producing an adhesive bond between a first bond area and a second bond area.

The manufacture of complex industrial apparatus requires the bonding of different materials. Particularly exacting requirements are imposed on bonds subject to pressure or tension. The problems associated with a vacuum-tight bond between different materials arise, for example, in connection with the production of X-ray image intensifiers. Here it is necessary to bond components of glass, metal, and ceramic to one another, with the bonds necessarily being vacuum-tight and stable toward, for example, aggressive chemicals. In order to bond the various constituents of an X-ray image intensifier the following methods are employed at present. A bond between ceramic components and components made of metal is produced by brazing, using for example a CuAg solder. Prior to soldering, the areas on the ceramic component must be made wettable and solderable by using a coat of, for example, MoMn, which has to be baked. The metal must additionally have a thermal expansion that is very similar to that of the ceramic material. Bonds between two parts made of metal, consisting for example of stainless steel or NiCo alloys, are normally produced by inert gas welding. Bonds between ceramic components and metallic components, which are not required to ensure vacuum-tightness, can be produced, for example, by shrink fitting. As metal use is made preferably of aluminum, because, compared to ceramic materials, aluminum exhibits a much greater thermal expansion. In order to obtain a stable bond between metal and ceramic, however, the two components must be suitably matched to one another in terms of construction.

Poly-o-hydroxyamide adhesives are known, for example, from British Patent No. GB 1,100,827, and Japanese Patent Nos. JP 2002131905 and JP 2002050621.

The manufacture of complex technical apparatus, such as X-ray image intensifiers, for example, therefore requires a multiplicity of different bonding techniques. In order to prevent destruction as a result of the high thermal load during the bonding step, the expansion coefficients of the materials must be attuned to one another. Particularly in connection with the bonding of ceramic materials to metals, the alloys that are suitable are generally very expensive. Methods where the bond is produced by shrink fitting necessitate increased constructional complexity and expenditure.

### SUMMARY OF THE INVENTION

It is accordingly an object of the invention to provide a method of producing an adhesive bond that overcomes the hereinafore-mentioned disadvantages of the heretofore-known devices of this general type and that provides poly-o-hydroxyamides for a method of bonding a first component to a second component that can be carried out simply and quickly.

With the foregoing and other objects in view, there is provided, in accordance with the invention, a special adhesive that bonds the first and second components. As compared with the methods customary to date this produces the advantage that independently of the material of the components, a lasting bond can be produced in a simple way. There is no need to first laboriously prepare the surfaces, such as in the case of brazing, for example, in order to be able to bond a ceramic component to a component made of metal. Furthermore, during the adhesive bonding of the components, the thermal load that arises is low, since the cyclization of the poly-o-hydroxyamide to the polybenzoxazole can be conducted at temperatures far lower than are necessary, for example, during brazing. There is a far greater freedom in the selection of materials, since owing to the lower thermal load there is no need, for example, to impose stringent requirements on the similarity between the expansion coefficients of the two materials. Furthermore, the poly-o-hydroxyamide is substantially insensitive to environmental effects, such as to oxidation by atmospheric oxygen, for example. Laborious processing under an inert gas atmosphere, such as in the case of welding, is therefore unnecessary. Moreover, the shape of the bond areas is arbitrary per se. All that is necessary is that the constructions of the first and second bond areas are harmonized with one another so as to produce an intimate contact between the two bond areas. The bond areas are normally configured as planar areas. It is possible to achieve a suitable reduction in the constructional complexity and expenditure involved in producing a bond, as compared with methods in which the join is brought about by shrink fitting.

The method of the invention uses a special adhesive to produce the adhesive bond. Poly-o-hydroxyamides are polyamides which can be prepared very easily by condensation from di-o-hydroxyamines with suitable dicarboxylic acid derivatives. Within their chain, they contain phenyl rings attached to which there is an amide group by way of which the polymer chain is continued. Positioned ortho to the nitrogen of the amide group that is attached to the phenyl ring is a hydroxyl group. When the poly-o-hydroxyamide is heated the o-hydroxyamide is cyclized to the oxazole, releasing water. The mechanism involved in the cyclization of poly-o-hydroxyamides to polybenzoxazoles is depicted diagrammatically below:

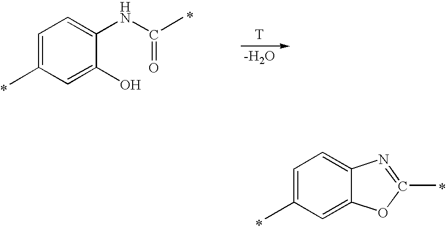

The star is intended to symbolize the continuation of the polymer chain. The polybenzoxazoles (PBO) obtained by the cyclization are polymers that have a very high thermal stability. They are substantially inert toward solvents and chemicals, so that the adhesive bond exhibits a high level of stability over long periods of time even under aggressive environmental conditions, for example, under increased atmospheric humidity or in a laboratory atmosphere. Poly-o-hydroxyamides exhibit good solubility in organic solvents and therefore can be processed easily. They can be coated easily, using for example a brush, to form a thin film, thereby allowing uniform distribution of the poly-o-hydroxyamide on the bond area.

Particular preference is given to using poly-o-hydroxyamides having a structure of the Formula I

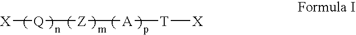

where

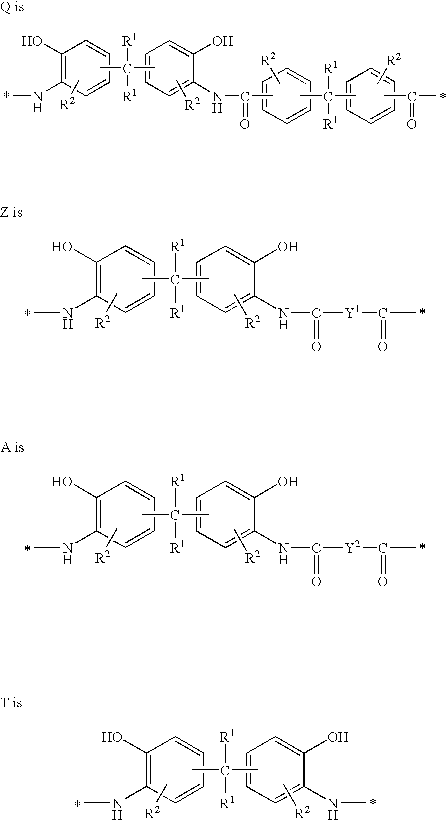

X is a radical selected from the group consisting of

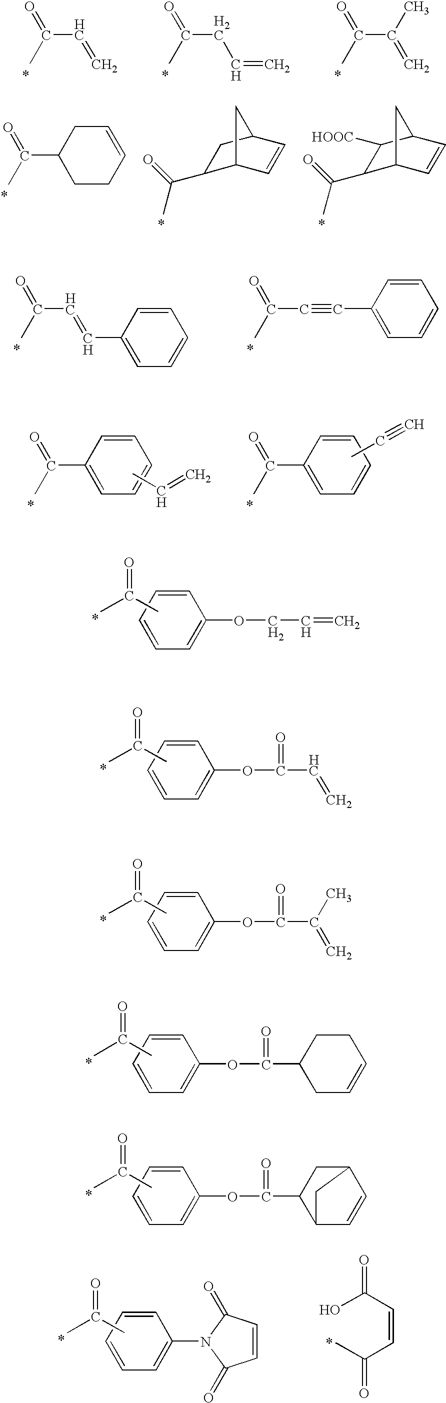

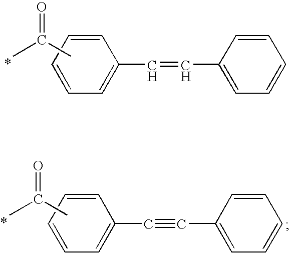

R¹ is a radical selected from the group consisting of

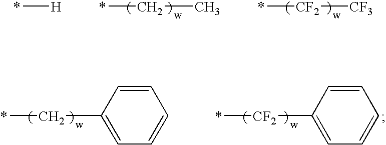

R² is a radical selected from the group including a hydrogen atom, a trifluoromethyl radical, an alkyl radical having from 1 to 10 carbon atoms,

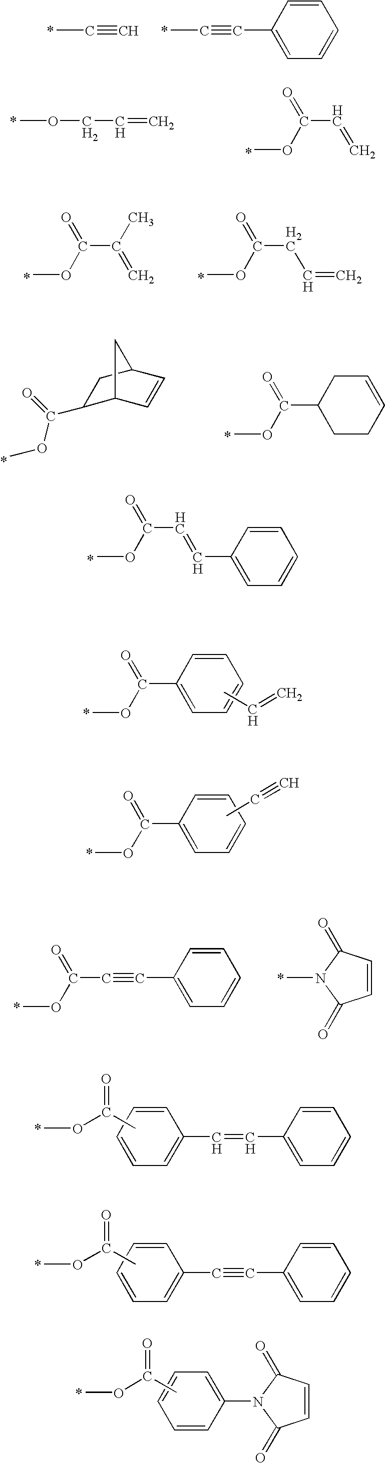

R³ is an alkyl radical having 1 to 10 carbon atoms or an aryl radical having 5 to 22 carbon atoms;

R⁴ is a divalent radical selected from the group including

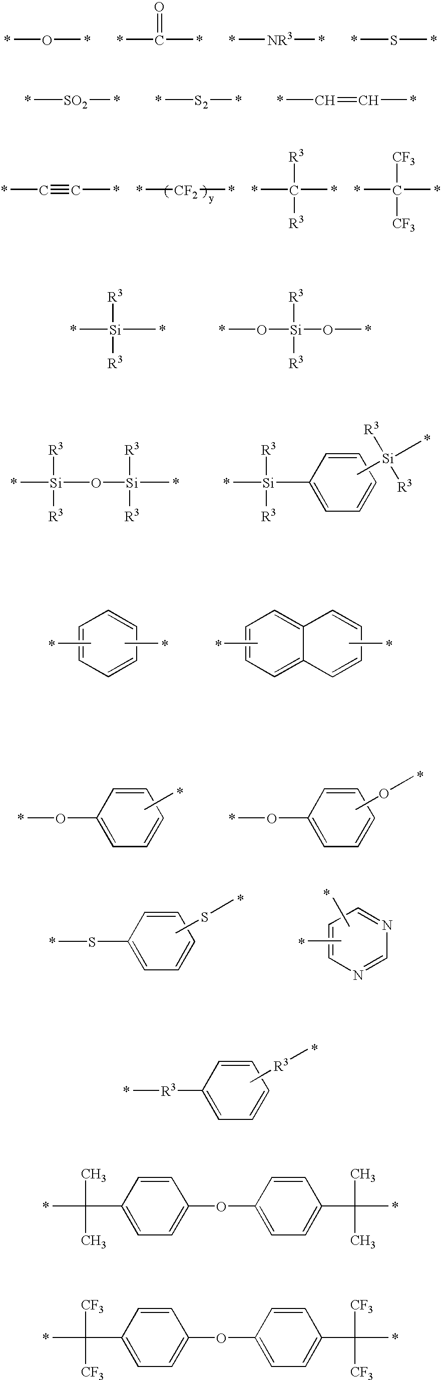

Y¹ and Y² each independently of one another are a radical selected from the group including

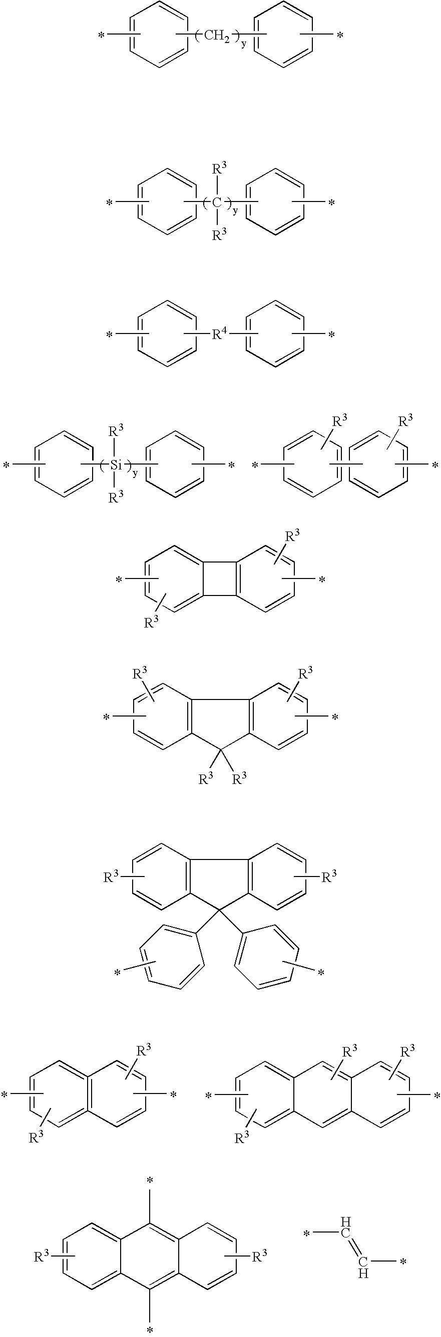

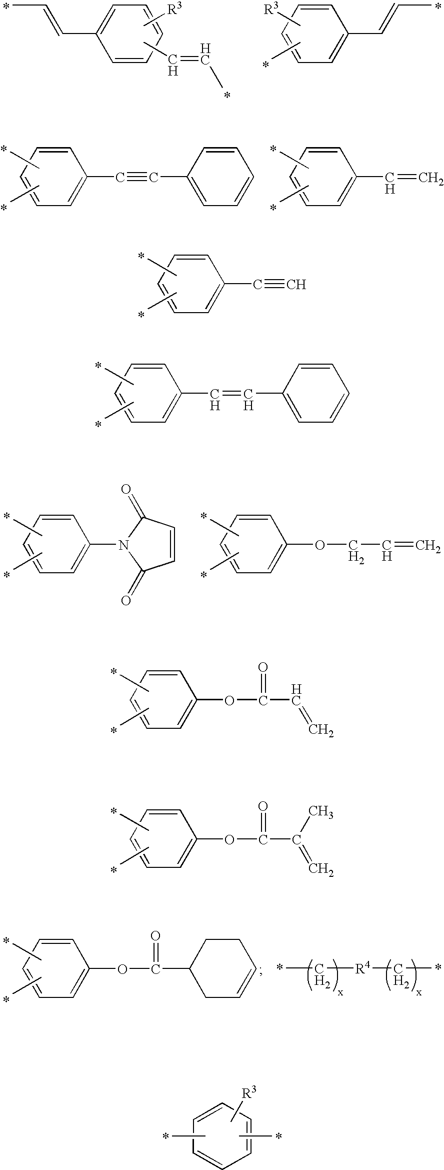

where if R⁴═—CH₂-x=0-10, and additionally

n is a number between 1 and 100;

m is a number between 1 and 100;

p is a number between 0 and 50;

x is a number between 1 and 10;

y is a number between 1 and 10; and

w is a number between 0 and 10.

Of course, in the preparation of the poly-o-hydroxyamides of the Formula I, no polymer molecules having a uniform chain length are obtained; instead, a molecular weight distribution is produced. Whereas for individual polymer molecules the indices indicated above adopt integral values, intermediate 15 values as well result for the molecular weight distribution. In preparing the poly-o-hydroxyamides the aim is for a narrow molecular weight distribution. The preparation is conducted so that the maximum of the molecular weight distribution lies within the ranges defined by the indices indicated above. The molecular weight distribution can be determined by standard techniques, such as gel chromatography techniques.

The poly-o-hydroxyamides of the Formula I are of very good solubility in many organic solvents and are therefore easy to apply to the bond areas, where they form a uniform film. By heating to temperatures of 200-500° C the poly-o-hydroxyamides of the Formula I are readily cyclized to the polybenzoxazole. Despite the elimination of water during the cyclization, no defect sites occur, such as blisters or cracks. The polybenzoxazoles exhibit high temperature stability and high resistance toward chemicals, such as solvents, aggressive gases or atmospheric humidity.

The polybenzoxazoles formed in the cyclization of the poly-o-hydroxyamides of the Formula I preferably possess a structure of the Formula II:

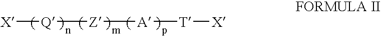

where

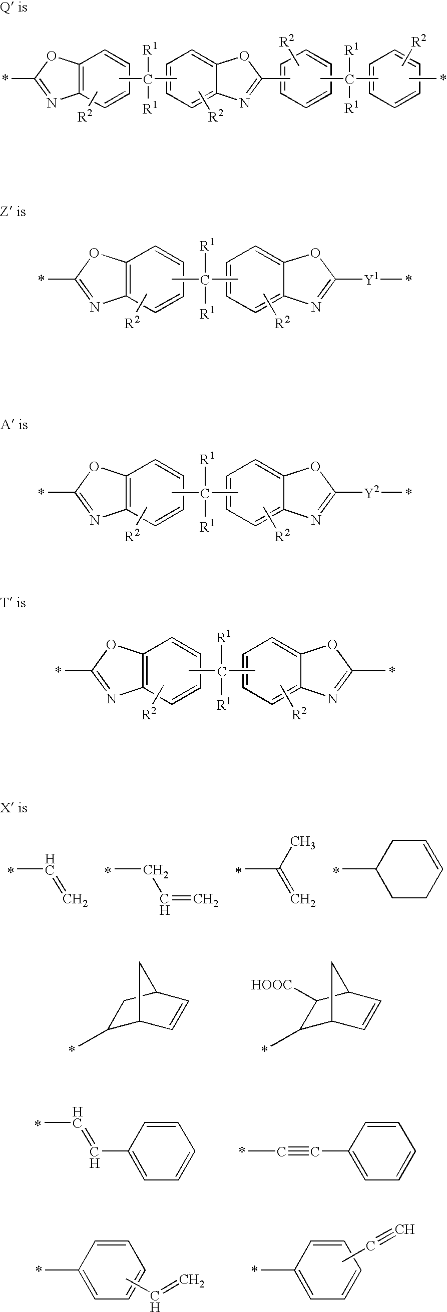

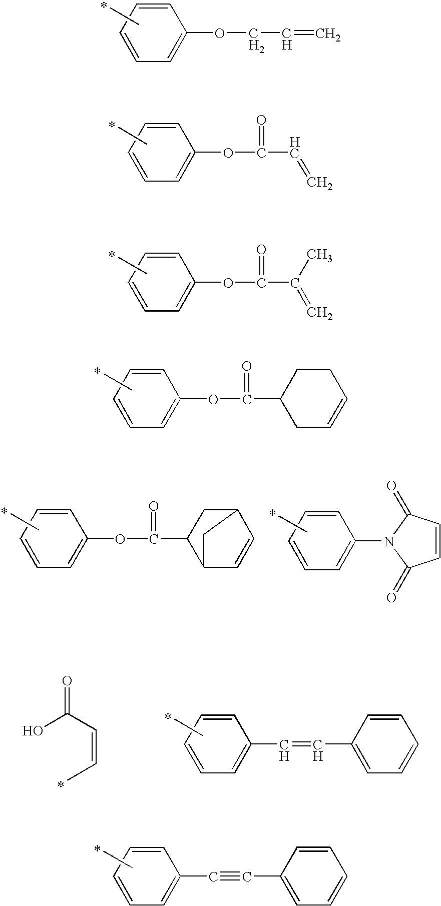

and R¹, R², R³, R⁴, n, m, p, x, y, and w are as defined above.

Preferably, R¹ is a trifluoromethyl radical.

The poly-o-hydroxyamides of the formula I can be prepared by polycondensation of di-o-hydroxyamines with suitable dicarboxylic acids. To prepare poly-o-hydroxyamides of the formula I, a bisaminophenol of the Formula III

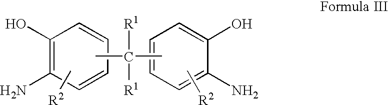

in which R¹ and R² are as defined above

is reacted with an activated dicarboxylic acid derivative of the Formula IV

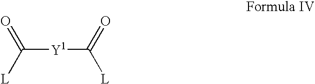

where L is an activating group and Y¹ is as defined above.

As activating group L it is possible to use customary activating groups. Thus, for example, acid chlorides can be used. The reaction of the dicarboxylic acid with a bis-o-aminophenol can also take place in the presence of a carboxylic-acid-activating compound, such as carbonyl diimidazole, dicyclohexylcarbodiimide, or hydroxy-benzotriazole, for example. Reagents suitable in principle include all those that bind the water of reaction to themselves.

In addition to the dicarboxylic acid represented in the formula IV it is possible to use further dicarboxylic acids as comonomers. Thus, the reaction can be conducted in the presence of an activated dicarboxylic acid derivative of the Formula V

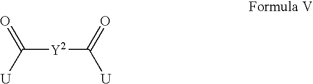

where U is an activating group and Y² is as defined above.

Examples of suitable activating groups include the groups indicated above for L. The polymerization can be conducted such that the compounds of Formulas III, IV, and V are present simultaneously in the reaction mixture. In that case, the distribution of the repeating units derived from the dicarboxylic acids of the Formulas IV and V within the polymer is random. Alternatively, the polymerization can be conducted in the form of a block polymerization. For that purpose, first of all, a polymer is prepared from the compounds of the Formulas III and IV. Then, following the preparation of the polymer, the dicarboxylic acid derivative of the formula V and any further bis-o-aminophenol of the formula III are added. When the polymerization is over, end groups X are attached to the ends of the polymer, on the free amino groups. The reagents are derived from the structures of the group X shown above, using in each case an activated carboxylic acid derivative, such as an acid chloride.

The polymerization is conducted preferably in the presence of a base. The base neutralizes the liberated acids.

Examples of suitable bases include pyridine, triethylamine, diazabicyclooctane, and polyvinylpyridine. In principle, however, it is also possible to use other bases to neutralize the acid. Particular preference is given to those bases that are readily soluble in the solvent used for the synthesis, e.g. N-methylpyrrolidone, and in water or water/alcohol mixtures, or to those which are completely insoluble in the solvent, such as crosslinked polyvinylpyridine.

Examples of suitable solvents for the polymer synthesis include γ-butyrolactone, tetrahydrofuran, N-methylpyrrolidone and dimethylacetamide. However, use can be made per se of any solvent in which the starting components are readily soluble.

To produce the adhesive assembly, the poly-o-hydroxyamide can be applied only to one of the bond areas, which then constitutes the first bond area. Advantageously, however, the poly-o-hydroxyamide is also applied to the second bond area. Thereafter, the two bond areas covered with the poly-o-hydroxyamide are pressed against one another, so that an adhesive assembly is produced from the poly-o-hydroxyamide-covered first bond area and the poly-o-hydroxyamide-covered second bond area. The films of adhesive produced from the poly-o-hydroxyamide on the first and second bond areas are made as thin as possible. After the adhesive assembly has been produced, cyclization then takes place to the polybenzoxazole in the manner described above, by heating the adhesive assembly.

As already mentioned, poly-o-hydroxyamides dissolve readily in organic solvents. Neat, poly-o-hydroxyamides exhibit a high viscosity as a function of their chain length, which can hinder the application of the adhesive to the bond areas. Preferably, therefore, the poly-o-hydroxyamide is applied in solution in a solvent to the first and/or second bond area. The solvent is subsequently evaporated by venting the adhesive-clad bond areas for a certain time, for example. If desired, the solvent can also be removed under reduced pressure (i.e. less than one atmosphere). Thereafter the adhesive-clad bond areas are pressed against one another and then the poly-o-hydroxyamide is converted into the polybenzoxazole by heating. Examples of suitable solvents include acetone, cyclohexanone, diethylene glycolmonoethyl and diethyl ether, N-methylpyrrolidone, y-butyrolactone, ethyl lactate, methoxypropyl acetate, tetrahydrofuran, ethyl acetate, and mixtures of the stated solvents. Other solvents can likewise be used provided that they dissolve the poly-o-hydroxyamide in a clear solution.

In order to be able to divert any weak leakage currents that may occur, the adhesive bond can also be made electrically conductive. For this purpose, for example, a conductive material is added to the poly-o-hydroxyamide. For greater ease of processing, the electrically conductive material is added preferably in powder form, so giving a paste that can then be applied to the bond areas. The amount of the conductive material is suitably chosen so as not or not substantially to affect the adhesion of the poly-o-hydroxyamide or of the polybenzoxazole. Based on the amount of the poly-o-hydroxyamide, the electrically conductive compound is added preferably in an amount of from 5 to 40% by weight, more preferably from 5 to 10% by weight.

As conductive material, it is possible per se to use any material that is electrically conductive and can be mixed with the poly-o-hydroxyamide to form a paste. A particularly preferred electrically conducted material used is carbon black, since this mixes easily with the poly-o-hydroxyamide and, furthermore, is inexpensively available. To prepare the paste the carbon black is combined with the poly-o-hydroxyamide and, where appropriate, a solvent and commixed for several hours, for example, using a propeller stirring rod. The paste can then be applied to the bond areas as described above.

The adhesive assembly acquires its stability through the cyclization of the poly-o-hydroxyamide to the polybenzoxazole. In order to achieve complete cyclization the adhesive assembly is heated preferably to a temperature of more than 400° C. By raising the temperature, it is possible to increase the rate at which cyclization to the polybenzoxazole takes place. At the same time, however, an excessive thermal load on the components should be avoided, so as to prevent, for example, difficulties caused by differing expansion coefficients of the material of the components. Generally, therefore, the chosen temperature for cyclization to the polybenzoxazole is lower than 600° C., preferably lower than 500° C.

Cyclization to the polybenzoxazole is accompanied, as already described above, by the formation of water, which escapes from the adhesive layer. This water is preferably removed rapidly by, for example, heating the adhesive assembly under reduced pressure.

As mentioned previously, it is possible for weak leakage currents to be diverted by making the adhesive bond electrically conductive. An electrical connection between the first and second components can also be produced in other ways, however. For example, a bridging conductivity also can be brought about by forming an electrically conductive connection between the first and second components using a wire contact. A further possibility is to bridge the adhesive assembly with a conductive paste. In that case, the conductive paste is applied to the join between first and second component, so that both components are partly covered by the conductive paste. For this purpose, it is possible to use standard conductive pastes available from commercial suppliers.

One great advantage of the method of the invention is that the adhesive bond is substantially independent of the materials from which the first and second components are constructed. In one preferred embodiment, therefore, first and second component are constructed from different materials. The method of the invention can be used, for example, to bond ceramic materials, such as aluminum oxide, to metals, such as aluminum or stainless steel. It is, however, also possible to produce a bond between two components made of different metals. Self-evidently, components made from identical materials can also be bonded using the method of the invention.

The method of the invention is particularly suitable for the assembly of X-ray image intensifiers. Preferably, therefore, first and second component are formed by constituents of an X-ray image intensifier. In the assembly methods customary to date, a variety of techniques have been used to join the constituents of the X-ray image intensifier. With the method of the invention, it is now possible to perform all of the joining operations by adhesive bonding. This simplifies assembly substantially and hence allows a substantial reduction in costs.

The method of the invention can be applied to the bonding of any constituents of the X-ray image intensifier. With particular advantage, however, the method is applied to the bonding of constituents that are composed of different materials. Constituents of the X-ray image intensifier that can be bonded with the method of the invention are selected, for example, from the group consisting of vacuum vessel, input screen, support ring, insulator sleeve, anode support and anode.

Other features that are considered as characteristic for the invention are set forth in the appended claims.

Although the invention is illustrated and described herein as embodied in a method of producing an adhesive bond, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1A-1D are sectional views showing a sequence of worksteps of a method according to the invention in which two components are adhered by a poly-o-hydroxyamide adhesive that forms a layer of polybenzoxazole;

FIG. 2 is a diagrammatic, sectional view of an X-ray image intensifier;

FIG. 3 is a longitudinal section through an X-ray image intensifier; and

FIG. 4 is an enlarged, detail sectional view of FIG. 3 showing the fastening of an electrode by shrink fitting.

### DESCRIPTION OF THE PREFERRED EMBODIMENTS

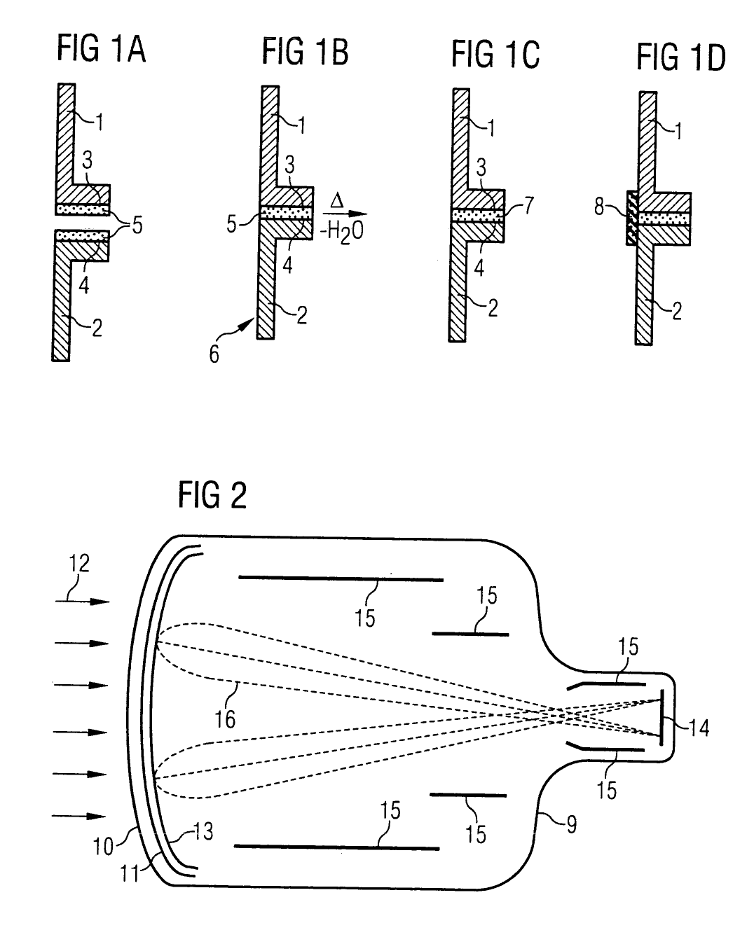

Referring now to the figures of the drawings in detail and first, particularly to FIG. 1 thereof, there is shown a first component 1 and a second component 2, having, respectively, a first bond area 3 and a second bond area 4. Applied to each of the first bond area 3 and to the second bond area 4 is a layer of a poly-o-hydroxyamide adhesive 5. The poly-o-hydroxyamide adhesive includes a poly-o-hydroxyamide, preferably a poly-o-hydroxyamide of the Formula I, and a solvent. A conductive material as well, especially carbon black, may have been added if desired to the poly-o-hydroxyamide adhesive. To remove excess solvent, the layer of poly-o-hydroxyamide adhesive 5 is first of all vented. The solvent can also be removed, however, under reduced pressure, for example. First and second bond areas 3, 4 are subsequently pressed against one another so that the two films of poly-o-hydroxyamide adhesive 5 come into contact. This produces the adhesive assembly 6 depicted in FIG. 1. The first component 1 and the second component 2 are now bonded via the bond areas 3, 4 by the poly-o-hydroxyamide adhesive 5. The adhesive assembly 6 is then heated. For this purpose, for example, the adhesive assembly 6 can be transferred to an oven, which preferably can be evacuated. The adhesive assembly 6 is heated to a temperature of 300 to 600° C., preferably 400 to 500° C. The poly-o-hydroxyamide present in the adhesive layer 5 is cyclized to the polybenzoxazole, and water is eliminated. The water is preferably removed by evacuating the oven. Following cyclization, the adhesive assembly depicted in FIG. 1C is obtained. Disposed between the bond areas 3, 4 of the first component 1 and of the second component 2 there is now a layer 7 of polybenzoxazole that has a very high thermal stability and a high resistance toward chemicals. At this stage, if the adhesive layer 7 contains no conductive material, an electrically conductive paste 8 can be applied finally to the bondsite, so that the first component 1 and the second component 2 have an electrically conducting connection and so are able to carry off leakage currents.

The method of the invention is particularly suitable for the assembly of X-ray image intensifiers. FIG. 2 depicts an X-ray image intensifier in diagram form, as a longitudinal section. The X-ray image intensifier includes a vacuum vessel 9 including, on one side, an input screen 10. For this purpose, on the input screen 10 side, the vacuum vessel 9 is coated on the inside with a fluorescent layer 11, composed for example of CsI doped with NaI. The fluorescent layer 11 can be brought to fluoresce by incident X-radiation 12. Mounted in turn on the fluorescent layer 11 is a photocathode 13, with which the fluorescent image can be converted into an electronic image. Provided on the opposite side of the vacuum vessel 9 is an output screen 14, which is composed of a material that can be excited to fluorescence by electrons.

Electrodes 15 build up an electrostatic field that serves to display the image generated on the input screen 10 on the output screen 14. The electrons 16 emerging from the photocathode 13 are accelerated to, for example, 25 to 30 kV. In general, the electrode set 15 is composed of 3 to 5 electrodes, depending on the construction, size, and functional scope of the intensifier.

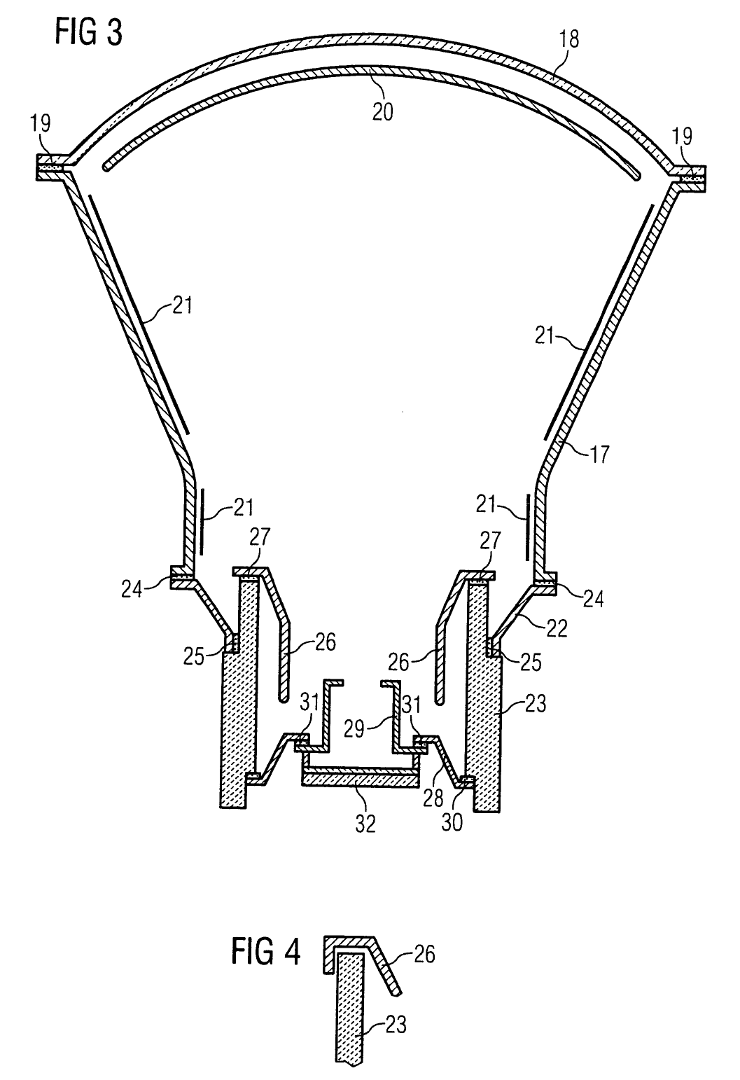

FIG. 3 shows a more detailed view of a section through an X-ray image intensifier. The X-ray image intensifier includes a vacuum vessel 17, which on one side is closed off by an input screen 18. The input screen 18 is composed preferably of a material that is only a poor absorber for X-radiation, such as aluminum. Provided between input screen 18 and vacuum vessel 17 are connecting points 19. Mounted on the input screen 18 is a fluorescent layer (not shown) and a photocathode 20. Provided on the inside of the vacuum vessel 17, moreover, are electrodes 21 that focus the electrons emitted by the photocathode 20. The electrodes 21 can be applied in a thin-film operation, for example by vapor deposition or sputtering. Via a support ring 22, the vacuum vessel 17 is connected to an insulator 23. The insulator 23 is composed of a ceramic material, for example aluminum oxide. Disposed between the vacuum vessel 17 and the support ring 22 is a connecting point 24 and, between support ring 22 and insulator 23, a connecting point 25. In the upper section of the insulator 23 there is an electrode 26 which is connected to the insulator 23 by way of a connecting point 27. At the rear side of the X-ray image intensifier, the insulator 23 is connected via an anode support 28 to the anode 29. Between the insulator 23 and the anode support 28 there is a connecting point 30 and between the anode support 28 and the anode 29 there is a further connecting point 31. Disposed at the rear side of the X-ray image intensifier, finally, is an output screen 32, on which the electrons emitted by the photocathode 20 are imaged. The output screen 32 is composed of a fluorescent material.

The connecting points 30 and 25 have to date been implemented by first grinding the contact point on the side of the insulator 23 and then metalizing the ground surface by applying and baking an MoMn paste. The support ring 22 is subsequently bonded to the insulator 23 in a vacuum or inert gas soldering operation by using AgCu solder at about 800° C. For this purpose the support ring 22 must be produced from a material whose thermal expansion is adapted to that of the ceramic of the insulator 23. Materials of this kind, however, are relatively expensive.

The connecting points 24, 19, and 31 between different metals have to date been joined by welding the components using inert gas welding (TIG welding). The connecting point 19 includes, on the one hand, the aluminum of the input screen 18 and, on the other hand, the stainless steel of the vacuum vessel 17. TIG welding of aluminum and stainless steel generally leads to brittle connections, for example, of the formula Fe₃Al and/or Al₃Fe. Brittleness, however, means potential cracking under mechanical or thermomechanical strain. Consequently, in a costly and inconvenient process, by using diffusion welding or friction welding, for example, a narrow ring of stainless steel plate is applied to the input screen 18 in the region of the connecting point 19. If this operation is conducted skillfully, an interdiffusion zone is formed and the brittle phases are substantially avoided. Finally, this intermediate ring is joined to the vacuum vessel 17 by TIG welding.

The electrode 26 has to date been joined to the insulator 23 by shrink fitting. For that purpose, it is necessary for the electrode 26, as depicted in FIG. 4, to have a suitable geometry in order to be able to be joined non-positively to the insulator 23. This requires that the parts to be bonded are matched precisely to one another, for example by grinding the surface of the insulator 23 correspondingly in the region of the shrink fit. In order to be able to fasten the electrode 26 to the insulator 23, the two parts are first heated to about 200 to 250° C. and slowly cooled after the electrode 26 has been placed on the insulator 23. As a result of the different expansion coefficients of the material of the insulator 23 and of the electrode 26, it is possible to achieve a firm connection between the two components. By employing the method of the invention it is possible to implement all of the connecting points (19, 24, 25, 27, 30, 31) by adhesive bonding. No special pretreatment of the surfaces is needed. The most that is necessary is that the surfaces be cleaned. As already depicted diagrammatically in FIG. 1, only the areas to be bonded are covered with a thin film of a poly-o-hydroxyamide adhesive and are then placed against one another. By heating, the poly-o-hydroxyamide is subsequently converted into the corresponding poly-benzoxazole. This substantially simplifies in particular the connections 25, 27 and 30 between the ceramic material of the insulator 23 and the metal support ring 22, the anode support 28 and the electrode 26. The electrode 26 can have a substantially simplified geometry, as depicted diagrammatically in FIG. 3, since only one bond area need be provided via which the electrode 26 can be bonded to a corresponding bond area of the insulator 23. The connecting point 19 as well can be produced in a simple way by adhesive bonding, with the advantage that there is no need at all for the intermediate ring and the associated diffusion or friction welding.

The sequence of the method steps in the production of the X-ray image intensifier depicted in FIG. 3 can be accomplished in various ways. Preferably, however, support ring 22, insulator 23, anode support 28 and anode 29 are first of all bonded to one another adhesively in just one operation and, after cyclization of the poly-o-hydroxyamide to the polybenzoxazole, are bonded to one another firmly and in vacuum-tight fashion. In a later step, the output screen 32 is joined to the anode support 28 and to the anode 29, an operation for which it is possible to employ any desired methods, including for example the adhesive bonding method of the invention. Since the connecting points 31, 30, 27 and 25 are produced under identical compression, generally under the external air pressure, the bondsites are not subject to any increased mechanical load.

In a second step, input screen 18, vacuum vessel 17 and the anode block produced in the first step are assembled and, as in the first step, are bonded adhesively to one another in a joint operation. It may be necessary here to protect the input screen 18 against excessive temperature load. The temperatures when cyclizing the poly-o-hydroxyamide to the polybenzoxazole should not substantially and not for two or more hours exceed levels of approximately 260° C. to 280° C. If higher temperatures are necessary, input screen 18 can be cooled, in order to counter destruction of the fluorescent layer. Preferably, only the connecting points 19 and 24 are heated locally for the polymerization.

The preparation of suitable poly-o-hydroxyamides is illustrated further with reference to examples.

The polyhydroxyamides of the invention are prepared using the following compounds:

Bisaminophenols:

bisaminophenol 1:2,2-bis(3-amino-4-hydroxyphenyl)hexa-fluoropropane

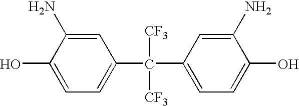

Dicarbonyl Chlorides:

dicarbonyl chloride 1:2,2-bis(4-chlorocarbonyl)phenyl-hexafluoropropane

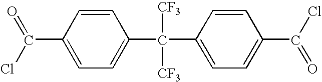

dicarbonyl chloride 2: diphenyl ether 4,4′-dicarbonyl chloride

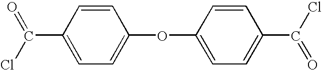

dicarbonyl chloride 3:5-norbornene-2,3-dicarbonyl dichloride

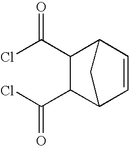

dicarbonyl chloride 4:5-phenylethynylisophthaloyl chloride

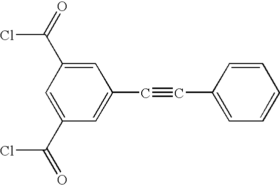

dicarbonyl chloride 5:5-allyloxyisophthaloyl dichloride

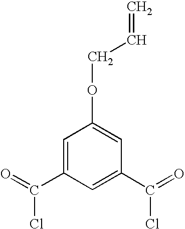

dicarbonyl chloride 6:2,6-naphthalenedicarbonyl dichloride

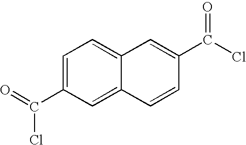

dicarbonyl chloride 7:4,4′-biphenyldicarbonyl dichloride

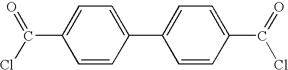

dicarbonyl chloride 8: terephthaloyl dichloride

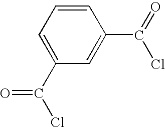

Reagents for Terminal Groups (Endcaps):

endcap 1: methacryloyl chloride

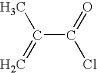

endcap 2:5-norbornene-2-carbonyl chloride

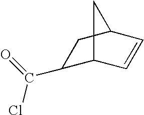

endcap 3:5-norbornene-2,3-dicarboxylic anhydride

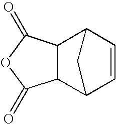

### EXAMPLE 1

Polyhydroxyamide 1

190.44 g (0.52 mol) of bisaminophenol 1 are dissolved in 720 ml of distilled N-methylpyrrolidone (NMP). Added dropwise to this solution at 10° C. and with stirring is a solution of 169.4 g (0.395 mol) of dicarbonyl chloride 1 and 29.16 g (0.0988 mol) of dicarbonyl chloride 2 in 960 ml of distilled y-butyrolactone (γ-BL). The mixture is stirred further at 10° C. for 1 hour and then at 20° C. for 1 hour. After the reaction mixture has again cooled to 10° C., 9.36 g (0.052 mol) of endcap 3 in solution in 120 ml of distilled 7-BL are added dropwise to it, and the resulting mixture is stirred at 10° C. for 1 hour and then at 20° C. for 1 hour. After cooling to 10° C., the reaction mixture is admixed with 91.2 ml (1.0868 mol) of pyridine in solution in 100 ml of distilled γ-BL, heated to room temperature, and stirred for 2 hours.

The polymer is isolated by filtering the reaction mixture and introducing the filtrate dropwise with stirring into a mixture of 2 l of deionized (DI) water and 400 ml of methanol, adding a further 5 l of DI water during the dropwise introduction.

The precipitated polymer is filtered off with suction and washed with 3 l of cold DI water. Following its isolation by suction filtration, the polymer is stirred twice at room temperature each time into 3 l of a 3% strength ammonia solution for 1 hour, after which it is filtered off with suction. The polymer is washed to neutrality with DI water, isolated by filtration, and dried at 50° C./10 mbar for 72 hours.

The polyhydroxyamide prepared in this way is readily soluble in solvents such as NMP, γ-BL, tetrahydrofuran, cyclohexanone, cyclopentanone, and diethylene glycol monomethyl ether.

### EXAMPLE 2

Polyhydroxyamide 2

25 g (0.06826 mol) of bisaminophenol 1 are dissolved in 90 ml of distilled NMP. Added dropwise to this solution at 10° C. and with stirring is a solution of 25.05 g (0.005836 mol) of dicarbonyl chloride 1 and 1.42 g (0.006485 mol) of dicarbonyl chloride 3 in 150 ml of distilled γ-BL. The mixture is stirred further at 10° C. for 1 hour and then at 20° C. for 1 hour. After the reaction mixture has again cooled to 10° C., 0.71 g (0.006826 mol) of endcap 1 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 2 was isolated and worked up as in example 1.

### EXAMPLE 3

Polyhydroxyamide 3

25 g (0.06826 mol) of bisaminophenol 1 are dissolved in 90 ml of distilled NMP. Added dropwise to this solution at 10° C. and with stirring is a solution of 16.7 g (0.0389 mol) of dicarbonyl chloride 1 and 7.83 g (0.02594 mol) of dicarbonyl chloride 4 in 150 ml of distilled γ-BL. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 3 was isolated and worked up as in example 1.

### EXAMPLE 4

Polyhydroxyamide 4

25 g (0.06826 mol) of bisaminophenol 1 are dissolved in 90 ml of distilled NMP. Added dropwise to this solution at 10° C. and with stirring is a solution of 16.7 g (0.0389 mol) of dicarbonyl chloride 1 and 6.69 g (0.02594 mol) of dicarbonyl chloride 5 in 150 ml of distilled γ-BL. The mixture is stirred further at 10° C. for 1 hour and then at 20° C. for 1 hour. After the reaction mixture has again cooled to 10° C., 1.06 g (0.006826 mol) of endcap 2 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 4 was isolated and worked up as in example 1.

### EXAMPLE 5

Polyhydroxyamide 5

25 g (0.06826 mol) of bisaminophenol 1 are dissolved in 90 ml of distilled NMP. Added dropwise to this solution at 10° C. and with stirring is a solution of 16.7 g (0.0389 mol) of dicarbonyl chloride 1 in 100 ml of distilled γ-BL. The mixture is stirred further at 10° C. for 1 hour and then at 20° C. for 1 hour. The mixture is cooled to 10° C. and 6.69 g (0.02594 mol) of dicarbonyl chloride 5 in solution in 50 ml of distilled γ-BL are added dropwise. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 5 was isolated and worked up as in example 1.

### EXAMPLE 6

Polyhydroxyamide 6

25 g (0.06826 mol) of bisaminophenol 1 are dissolved in 90 ml of distilled NMP. Added dropwise to this solution at 10° C. and with stirring is a solution of 16.7 g (0.0389 mol) of dicarbonyl chloride 1 in 100 ml of distilled γ-BL. The mixture is stirred further at 10° C. for 1 hour and then at 20° C. for 1 hour. The mixture is cooled to 10° C. and 6.56 g (0.02594 mol) of dicarbonyl chloride 6 in solution in 50 ml of distilled γ-BL are added dropwise. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 6 was isolated and worked up as in example 1.

### EXAMPLE 7

Polyhydroxyamide 7

25 g (0.06826 mol) of bisaminophenol 1 are dissolved in 90 ml of distilled NMP. Added dropwise to this solution at 10° C. and with stirring is a solution of 16.7 g (0.0389 mol) of dicarbonyl chloride 1 in 100 ml of distilled γ-BL. The mixture is stirred further at 10° C. for 1 hour and then at 20° C. for 1 hour. The mixture is cooled to 10° C. and 7.24 g (0.02594 mol) of dicarbonyl chloride 7 in solution in 50 ml of distilled γ-BL are added dropwise. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 7 was isolated and worked up as in example 1.

### EXAMPLE 8

Polyhydroxyamide 8

25 g (0.06826 mol) of bisaminophenol 1 are dissolved in 90 ml of distilled NMP. Added dropwise to this solution at 10° C. and with stirring is a solution of 16.7 g (0.0389 mol) of dicarbonyl chloride 1 in 100 ml of distilled γ-BL. The mixture is stirred further at 10° C. for 1 hour and then at 20° C. for 1 hour. The mixture is cooled to 10° C. and 5.266 g (0.02594 mol) of dicarbonyl chloride 8 in solution in 50 ml of distilled γ-BL are added dropwise. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 8 was isolated and worked up as in example 1.

### EXAMPLE 9

Polyhydroxyamide 9

25 g (0.06826 mol) of bisaminophenol 1 are dissolved in 90 ml of distilled NMP. Added dropwise to this solution at 10° C. and with stirring is a solution of 22.26 g (0.05187 mol) of dicarbonyl chloride 1, 1.91 g (0.006484 mol) of dicarbonyl chloride 2 and 1.97 g (0.006484 mol) of dicarbonyl chloride 4 in 150 ml of distilled γ-BL. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 9 was isolated and worked up as in example 1.

### EXAMPLE 10

Polyhydroxyamide 10

25 g (0.06826 mol) of bisaminophenol 1 are dissolved in 90 ml of distilled NMP. Added dropwise to this solution at 10° C. and with stirring is a solution of 22.26 g (0.05187 mol) of dicarbonyl chloride 1 and 1.91 g (0.006484 mol) of dicarbonyl chloride 2 in 120 ml of distilled 7-BL. The mixture is stirred further at 10° C. for 1 hour and then at 20° C. for 1 hour. The mixture is cooled to 10° C. and 1.67 g (0.006484 mol) of dicarbonyl chloride 5 in solution in 50 ml of distilled γ-BL are added dropwise. The mixture is stirred further at 10° C. for 1 hour and then at 20° C. for 1 hour. After the reaction mixture has again cooled to 10° C., 1.12 g (0.006826 mol) of endcap 3 in solution in 50 ml of distilled γ-BL are added dropwise to it, and the resulting mixture is stirred at 10° C. for 1 hour and then at 20° C. for 1 hour. After cooling to 10° C., the reaction mixture is admixed with 11.5 ml (0.1427 mol) of pyridine in solution in 50 ml of distilled γ-BL, heated to room temperature, and stirred for 2 hours.

Polyhydroxyamide 10 was isolated and worked up as in example 1.

### EXAMPLE 11

Determination of the Thermal Stabilities

All of the polyhydroxyamides prepared exhibit thermal stabilities of >500° C. according to TGA analyses (instrument: STA 1500 from Rheometric Scientific, heating rate: 5 K/min, inert gas:argon). The isothermal mass loss per hour (at 400° C.) is <0.5%.

Accordingly, the polyhydroxyamides prepared meet the requirements for the applications indicated at the outset.

### EXAMPLE 12

Preparation of Polymer Solutions

30 g of the polyhydroxyamides prepared in examples 1 to 10 are dissolved in 70 g of distilled NMP (VLSI-Selectipur®) or distilled γ-BL (VLSI-Selectipur®). Dissolving takes place appropriately on a shaker apparatus at room temperature. The solution is subsequently subjected to pressure filtration through a 0.2 μm filter into a cleaned, particle-free glass sample vessel. The viscosity of the polymer solution can be altered by varying the mass of polyhydroxyamide dissolved.

### EXAMPLE 13

Improvement of Adhesion by Adhesion Promoter Solutions

0.5 g of adhesion promoter (e.g., N-(2-aminoethyl)-3-aminopropylmethyldimethoxysilane) is dissolved at room temperature in 95 g of methanol, ethanol or isopropanol (VLSI-Selectipur®) and 5 g of DI water, the dissolution taking place into a cleaned, particle-free glass sample vessel. After standing at room temperature for 24 hours the adhesion promoter solution is ready to use. This solution can be used for a maximum of 3 weeks.

The adhesion promoter should produce a monomolecular film on the surface to be coated. The adhesion promoter can be applied appropriately by spin coating technology. For this purpose the adhesion promoter solution is applied via a 0.2 μm preliminary filter to the surface where bonding is to take place, followed by spinning at 5000 rpm for 30 seconds. This is followed in turn by a drying step at 100° C. for 60 seconds.

### EXAMPLE 14

Application of a Polyhydroxyamide by Spin Coating and Cyclization to the Polybenzoxazole

A processed silicon wafer with lands and trenches down to a minimum size of in each case approximately 150 nm is coated with the adhesion promoter as described in example 13. The filtered solution of the polyhydroxyamide, synthesized in accordance with example 1, is then applied to the wafer using a syringe and is distributed uniformly using a spin coater. The rotational speed of the spin coater here is 3000 rpm. The polymer is subsequently heated on a hotplate at 120° C. for 2 minutes.

### EXAMPLE 15

Determination of the Adhesion of the Poly-hydroxyamides on a Titanium Nitride Layer

A 4″ silicon wafer is sputter coated with a titanium nitride layer 50 nm thick. The solution obtained in example 12 is applied to this wafer by spin coating: 500 rpm for 5 seconds and 3500 rpm for 25 seconds. After a short softbake at 120° C. for 1 minute on a hotplate, 10 silicon chips measuring 4×4 mm², likewise surface coated with 50 nm titanium nitride by sputtering, are pressed onto the polyhydroxyamide film with a force of 2 N. This stack is then heat-treated in an oven at 400° C. for 1 hour under a nitrogen atmosphere. After cooling to room temperature, an adhesion test is carried out using a shear tester, Dage series 400. The average of the force for polyhydroxyamide 1 that is needed to remove the chips by shearing is 16.37 N/mm².

### EXAMPLE 16

Determination of the Adhesion of the Poly-hydroxyamides on a Tantalum Nitride Layer

The experiment is conducted in exactly the same way as described in example 15 with the difference that the surface of the wafer and of the chips consisted not of titanium nitride but instead of tantalum nitride. The average of the force for polyhydroxyamide 1 that is needed to remove the chips by shearing is 16.41 N/mm².

### EXAMPLE 17

Determination of the Adhesion of the Poly-hydroxyamides on a Silicon Wafer

The experiment is conducted in exactly the same way as described in example 15 with the difference that the surface of the wafer and of the chips consisted not of tantalum nitride but instead of silicon. The average of the force for polyhydroxyamide 1 that is needed to remove the Si chips by shearing is 17.04 N/mm².

### EXAMPLE 18

Comparative Example, Adhesion

A polyhydroxyamide is prepared in analogy to example 1 of U.S. Pat. No. 5,077,378 and as described in example 12 a solution in NMP is prepared. The adhesion is measured in the same way as described in examples 15 and 17. The averages measured are as follows:

titanium nitride surface: 14.71 N/mm²

tantalum nitride surface: 15.69 N/mm²

silicon surface: 15.21 N/mm²

### EXAMPLE 19

Determination of the Chemical Stability

The polyhydroxyamide 1 is applied from 30% strength solution (solvent: NMP) by spin coating to a 4″ silicon wafer, at 500 rpm for 5 seconds and at 3500 rpm for 25 seconds. Following a brief softbake on a hotplate at 120° C. for 1 minute, the wafer is heat-treated in an oven at 400° C. for 1 hour under a nitrogen atmosphere. After cooling to room temperature, the coated wafer is heated at 80° C. in NMP for 5 hours. Thereafter the wafer is dried under reduced pressure at 200° C. for 60 minutes and the mass difference is determined. The mass decrease is 0.6%.

### EXAMPLE 20

Determination of the Water Absorption

The polyhydroxyamide 1 is applied from 30% strength solution (solvent: NMP) by spin coating to a 4″ silicon wafer of known mass, at 500 rpm for 5 seconds and at 3500 rpm for 25 seconds. Following a brief softbake on a hotplate at 120° C. for 1 minute, the wafer is heat-treated in an oven at 400° C. for 1 hour under a nitrogen atmosphere. A Delta Range AT261 analytical balance is used to determine the mass of polybenzoxazole.

The coated wafer is subsequently stored in water at 80° C. for 10 hours. After the water has been blown off, the weight is taken again. The mass difference is used to calculate the percentage water absorption relative to the mass of polybenzoxazole. Water absorption found: 0.5%.

### EXAMPLE 21

Comparative example, water absorption For comparison, a 4″ silicon wafer is coated as described in example 20 with a polyhydroxyamide prepared in analogy to example 1 of U.S. Pat. No. 5,077,378. A water absorption of 2.2% is measured.

We claim:

1. A method of bonding components, which comprises:
preparing a first bond area on a first component;
applying a poly-o-hydroxyamide of a general Formula I on the first bond area;
preparing a second area on a second component;
applying the second bond area to the poly-o-hydroxyamide applied to the first bond area to produce an adhesive assembly; and
heating the adhesive assembly to cyclicize the poly-o-hydroxyamide to a polybenzoxazole;
the general formula I having the following structure: 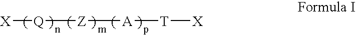
where 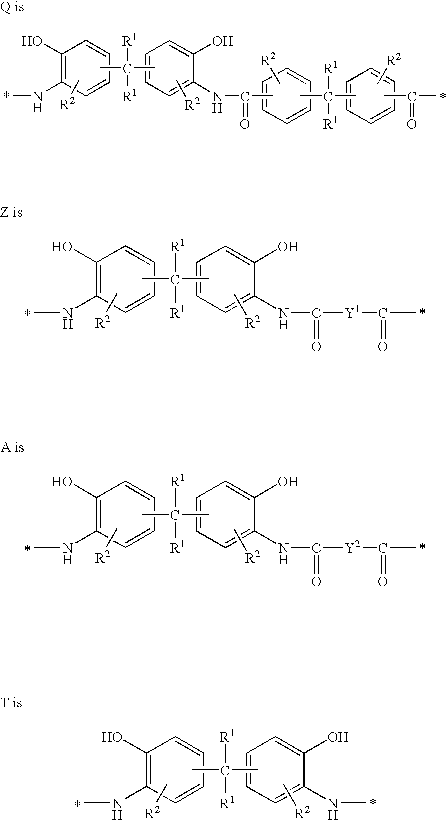
X is a radical selected from the group consisting of 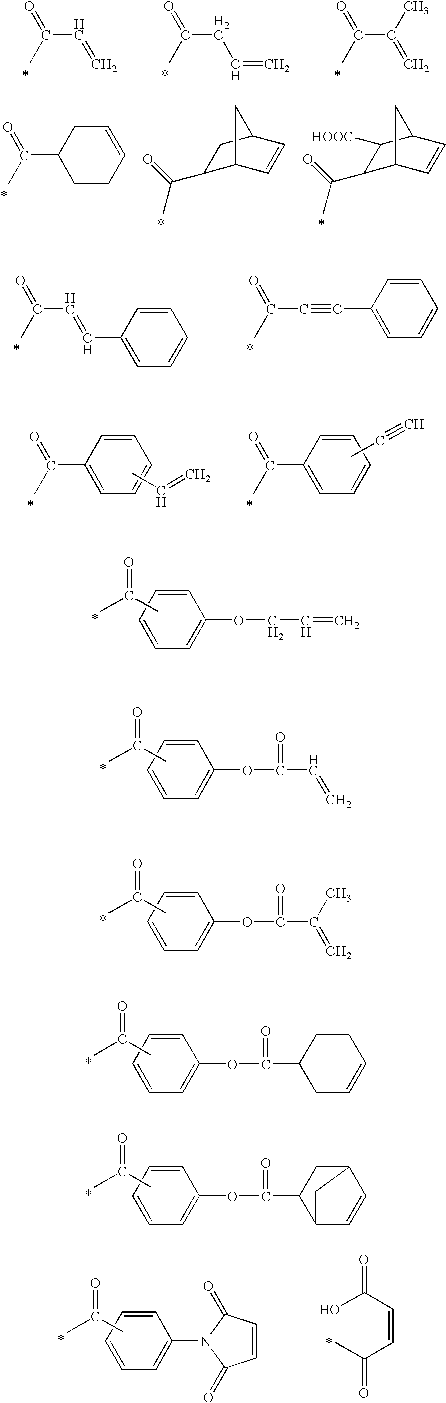 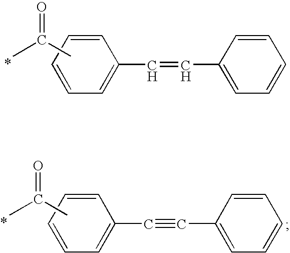
R¹is a radical selected from the group consisting of 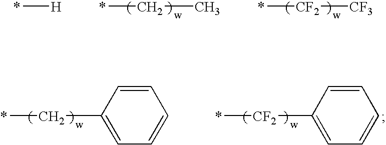
R² is a radical selected from the group consisting of a hydrogen atom, a trifluoromethyl radical, an alkyl radical having from 1 to 10 carbon atoms, 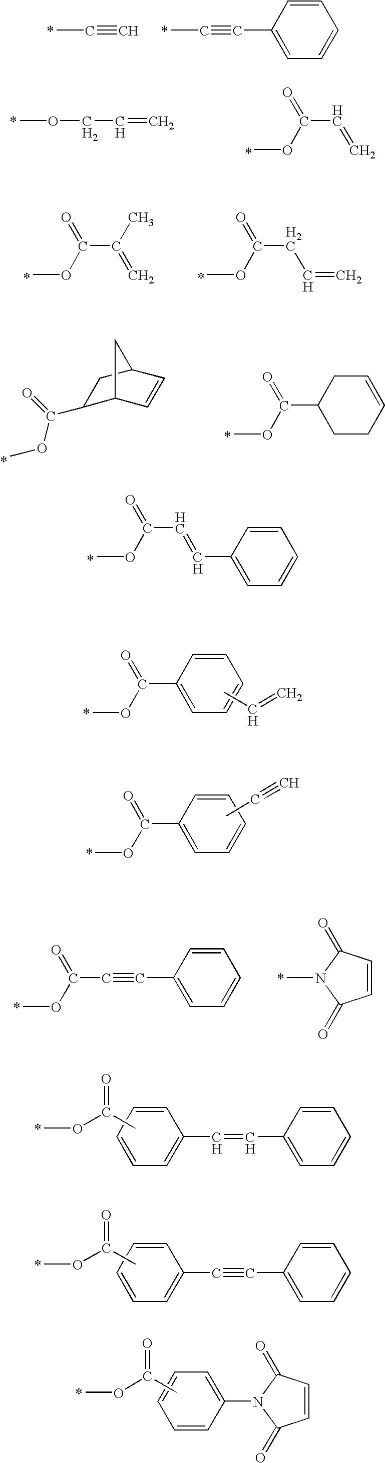
R³ is an alkyl radical having 1 to 10 carbon atoms or an aryl radical having 5 to 22 carbon atoms;
R⁴ is a divalent radical selected from the group consisting of 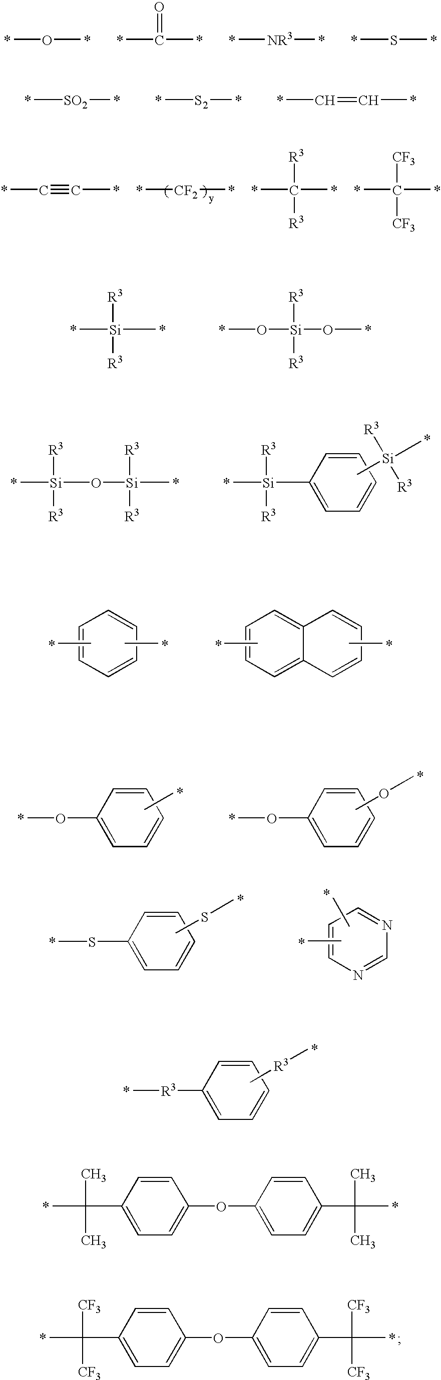
Y¹ and Y² each independently of one another are a radical selected from the group consisting of 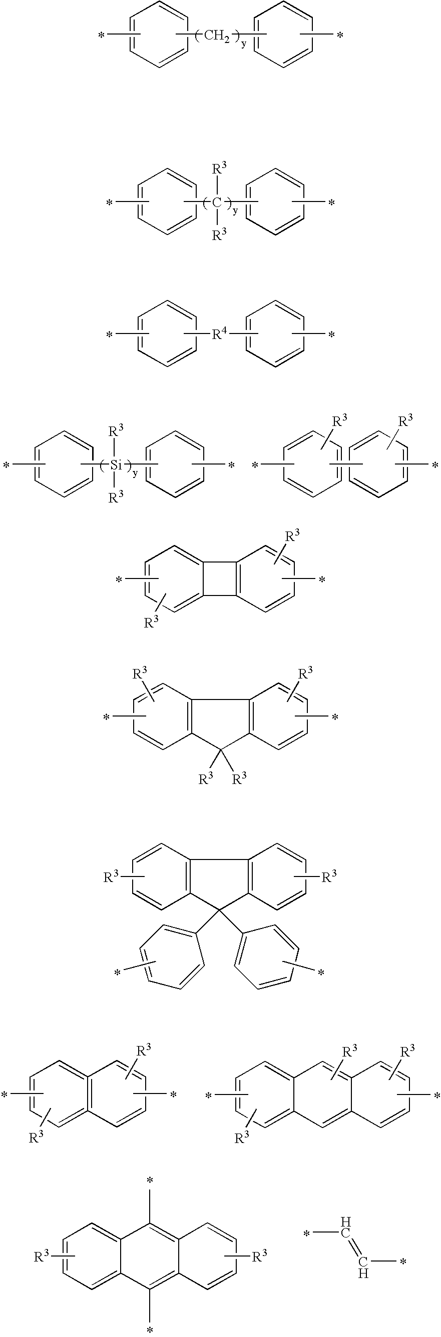 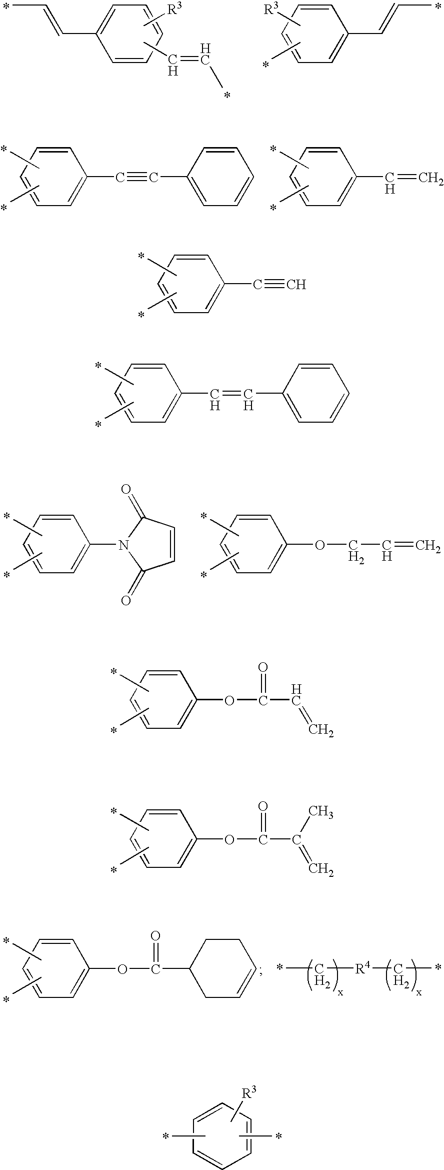
where if R⁴═—CH₂-x=0-10, and additionally
n is an integer between 1 and 100;
m is an integer between 1 and 100;
p is an integer between 0 and 50;
x is an integer between 1 and 10;
y is an integer between 1 and 10; and
w is an integer between 0 and 10.

2. The method according to claim 1, which further comprises additionally applying the poly-o-hydroxyamide of the general formula I to the second bond area to produce the adhesive assembly from the poly-o-hydroxyamide-covered first bond area and the poly-o-hydroxyamide-covered second bond area.

3. The method according to claim 1, where R¹ is a trifluoromethyl radical.

4. The method according to claim 1, which further comprises applying the poly-o-hydroxyamide in solution in a solvent to the first bond area.

5. The method according to claim 2, which further comprises applying the poly-o-hydroxyamide in solution in a solvent to the first and the second bond area.

6. The method according to claim 1, which further comprises adding a conductive material to the poly-o-hydroxyamide.

7. The method according to claim 6, which further comprises using carbon black as the conductive material.

8. The method according to claim 1, wherein the poly-o-hydroxyamide of the formula I is cyclized by heating the adhesive assembly to a temperature of more than 400° C.

9. The method according to claim 1, wherein the adhesive assembly is heated under a reduced pressure.

10. The method according to claim 9, wherein the reduced pressure is less than one atmosphere.

11. The method according to claim 1, which further comprises bridging the adhesive assembly with a conductive paste.

12. The method according to claim 1, which further comprises constructing the first and second components from different materials.

13. The method according to claim 1, wherein the first and second components are formed by constituents of an X-ray image intensifier.

14. The method according to claim 13, which further comprises selecting the constituents of the X-ray image intensifier from the group consisting of vacuum vessel, input screen, support ring, insulator sleeve, anode support, and anode.
